(19) United States
(12) Patent Application Publication
(10) Pub. No.: US 2008/0277254 A1
(43) Pub. Date: Nov. 13, 2008

(54) Keyboard assembly with adjustable keystroke

(76) Inventor: Poa Chin Chen, (US)

Correspondence Address: Goldstein, Faucett & Prebeg, LLP, Suite 400, 1177 West Loop South, Houston, TX, 77027, US

(21) Appl. No.: 12/151,028

(22) Filed: May 3, 2008

Related U.S. Application Data
(60) Provisional application No. 60/930,269, filed on May 15, 2007.

(30) Foreign Application Priority Data
May 10, 2007 (TW) 096116615

(51) Int. Cl. H01H 13/12

(52) U.S. Cl. 200/341

(57) ABSTRACT

Embodiments of the present disclosure relate to a keyboard structure comprising a bottom plate, a bridging device support board positioned above said bottom plate, and a plurality of keys positioned above said bridging device support board. The key board structure further includes a plurality of bridging devices positioned between said bridging device support board and each of said plurality of keys. Further, the said bottom plate is adapted to movably engage the said plurality of bridging devices for moving the said plurality of keys transversely relative to the said bottom plate.

### PRIORITY CLAIM

This Application claims priority to a Provisional Application, Ser. No. 60/930,269, filed on May 15, 2007, entitled “Key Switch.”

### CROSS-REFERENCES TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates generally to a keyboard assembly for a notebook computer (also known as a “laptop computer” or “portable computer”), and more specifically to a keyswitch design for a computer keyboard that allows for the height of the keys on the keyboard to be reduced when the notebook is closed, thus reducing the height of the computer keyboard as a whole when the notebook is closed and not in use.

Generally speaking, computer keyboards are used to input text and characters, and to also control the operation of their associated computers. Physically, computer keyboards generally comprise an arrangement of geometrically shaped buttons, or “keys” or “keycaps”, and are usually rectangular or near-rectangular in form. In many, if not most, current keyboard designs, when a key is depressed, the key in turn pushes down on a rubber cone (also known as a “rubber dome”) or other spring-type device located beneath the keycap. The rubber cone-shaped device engaged with the key acts as a spring to return the key to its original position after being depressed. In some instances the rubber cone also acts as an electrical conductor. The keys are supported and held in place by a bridging device and the rubber cone. When used as an electrical conductor, the rubber cone contacts the membrane circuit. This contact between the rubber cone and the membrane circuit causes current to flow through the membrane circuit, sending a signal to the computer. These components (i.e. key or “keycap”, rubber cone, bridging device, and membrane circuit) generally comprise a “keyswitch” or “keyswitch assembly”, along with other elements. A chip inside the computer receives the signal, decodes it, and then decides what to do on the basis of the key pressed (e.g. display a character on the screen, or perform some action).

A notebook computer comprises two primary sections—namely, a monitor or “top section”, and a housing or “bottom section”. The top section generally comprises a viewing screen, while the bottom section comprises various modules such as storage devices, CD/DVD drives, a keyboard, etc. The two sections are usually coupled together through the use of a hinge attached to the bottom end of the “top section”, and to the back end of the “bottom section”. Because notebook computers are intended to be portable, it is generally desirable for the notebook computer as a whole to be lightweight and as small as practical. One of the components of a notebook computer that contributes to the overall height of the computer is the keyboard.

Much like any other computer keyboard, a notebook computer keyboard generally comprises a plurality of keys and keyswitch assemblies. Each keyswitch assembly, generally speaking, may include a key or “keycap”, a bridging device, a bridging device support board, an electronic membrane circuit, a rubber cone disposed between the keycap and membrane circuit, and a bottom support board. Among other things, the rubber cone, in addition to acting as an electrical conduit or to cause an electrical signal, acts as a spring to return the keycap to its original position after it has been depressed during use. When the keycap is depressed, the rubber cone is compressed and triggers the membrane circuit, producing an electrical signal to the computer to which the keyboard is attached. After depression, the rubber cone acts as a spring to return the keycap to its original position.

Contributing to the overall height of the keyboard is the travel distance (or “stroke”) of the keycap when it is depressed during use. Generally speaking, the stroke of a key when depressed is from 2.5 millimeters to 3 millimeters. This stroke is only needed when the computer is in use, or in the case of a notebook computer when the notebook is open and in use. There is no need for this stroke when the notebook is closed, or not in use. Thus, the height of a notebook computer when closed could be reduced as much as 3 millimeters if the distance in the stroke could be minimized or eliminated.

In the preferred form, the keyswitch assembly of the keyboard of the present invention includes a one-piece slidable bottom plate used in conjunction with, or instead of, a bottom support board to support the bridging device. In those keyboards presently known in the art, the bottom support board is fixed in place, and therefore can not slide. In the present invention, the slidable bottom plate is coupled to each of the bridging devices of each of the keyswitches on the keyboard. In the preferred form, the slidable bottom plate has a constant force applied to it in the direction of the hinge(s) of the notebook computer (i.e. that portion of the notebook where the top and bottom sections of the notebook are joined so that the notebook can be opened and closed). That force can be in the form of a spring tending to push the slidable bottom plate, or a latch which tends to pull the slidable bottom plate, toward the hinge(s).

In the preferred form, the hinge(s) of the notebook computer is cam-shaped. The slidable bottom plate acts as a cam-follower as it is forced against the cam-shaped hinge(s). When the notebook is opened, the slidable bottom plate is forced away from the cam-shaped hinge(s) by the hinge(s), and allows the keyswitch to be forced upward, and in place and ready for use. When the notebook is closed, the slidable bottom plate is forced toward the hinge(s) by the cam-shape of the hinge(s), thus causing the keyswitch to close (thereby causing the keycap to be lowered), removing most if not all of the stroke, and resulting in a reduction in height of the keys of the keyboard.

Alternatively, when the notebook is closed, a lever could be used to engage the slidable bottom plate, causing the slidable bottom plate to slide horizontally, thus causing the bridging device of each of the keyswitches to fold downward, and thereby lowering all of the keycaps on the keyboard. By lowering all of the keycaps on the keyboard when the notebook is closed, the overall height of the notebook can be reduced.

2. Description of Related Art

Computer keyboards and keyswitches are well known in the art. U.S. Pat. No. 5,457,297 to Pao-Chin Chen provides an example of a notebook computer keyswitch design known in the art.

Known keyboards for notebook computers currently on the market measure approximately 6.5 millimeters in overall height, with 3 millimeters of stroke (or traveling distance) when an individual keycap is depressed during use when the notebook is open. It is generally desirable to maintain an approximate 2.5 millimeter to 3 millimeter stroke for individual keys on a notebook computer keyboard. Using existing keyboard designs, it is difficult to design a keyswitch assembly such that the overall height of the keyboard is less than 6 millimeters, if it is desired to keep the stroke of the individual keycaps greater than 2.5 millimeters.

The present invention allows for an overall height of the keyboard to be reduced to less than 4 millimeters, while keeping the stroke of the individual keycaps at a desired 3 millimeters during use. Correspondingly, since the overall height of the keyboard can be reduced from 6 millimeters to less than 4 millimeters, the overall height of the notebook computer can be reduced by more than 2 millimeters.

### SUMMARY OF THE INVENTION

Briefly described, as is illustrated in the accompanying drawings, in the preferred form, the present invention comprises the use of a one-piece slidable bottom plate disposed below the keycap and membrane circuit of each keyswitch of a computer keyboard in a notebook computer. The slidable bottom plate, in its preferred form, is engaged with each scissor-shaped bridging device within each keyswitch on a notebook computer keyboard through a hook secured to the slidable bottom plate, such that when the top of the notebook computer is closed, the slidable bottom plate slides horizontally, which in turn causes the hook to engage the bridging device of each keyswitch to pull its respective keycap downward, thereby reducing the distance between the bottom of the keyboard and the tops of the keycaps, and thereby reducing the overall height of the keyboard when the notebook is closed.

Those skilled in the art will appreciate that a slidable bottom plate structure of the present invention can be easily incorporated into any existing notebook computer keyboard design, or any other device that employs keys on a keyboard, to allow for the lowering of all the keycaps on a keyboard when the notebook is closed, through any number of mechanical designs. Other objects and features of the present invention will become apparent from the following detailed description considered in conjunction with the accompanying drawings. It is to be understood, however, that the drawings are offered solely for purpose of illustration and not as a definition of the limits of the invention.

### BRIEF DESCRIPTION OF THE DRAWINGS

The attached drawings demonstrate the effect of the slidable bottom plate on one type of keyswitch assembly. However, the same effect will result from any other keyswitch assembly that is engaged with a sliding member as described in the present invention.

FIG. 1 is an exploded view of a key switch according to the presented invention.

FIG. 2 is an illustration detailing the bridging device support board and an unassembled scissor-shaped bridging device.

FIG. 3 is a sectional view of a key switch according to the presented invention.

FIG. 4 is an illustration detailing how the slidable bottom plate interacts with the scissor-shaped bridging device to permit space for the key stroke when the device is opened.

FIG. 5 is an illustration detailing how the slidable bottom plate interacts with the bridging device to remove space used by the key stroke when the device is closed.

### DETAILED DESCRIPTION OF THE PREFERRED EMBODIMENTS

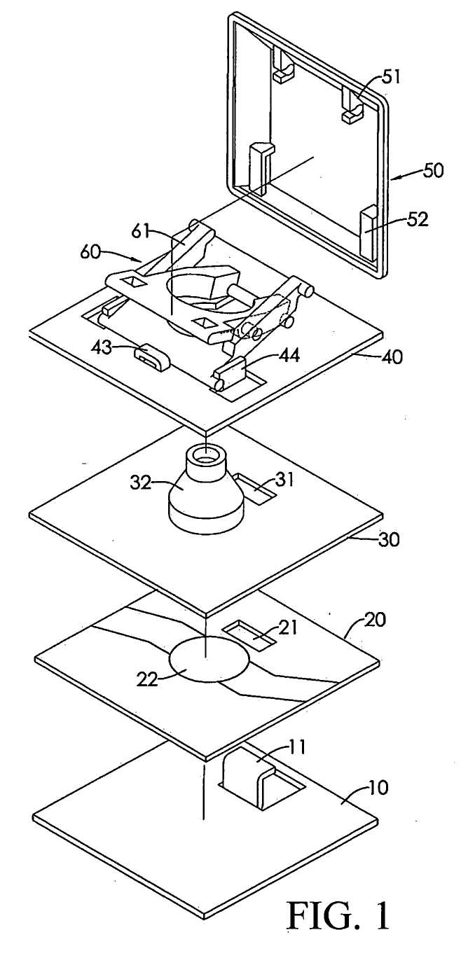

Referring to FIG. 1, a preferred embodiment of this invention is comprised of bottom plate (10), membrane circuit (20), rubber assembly (30), bridging device support board (40), keycap (50), and bridging device (60). Bottom plate (10) is a relatively thin plate, on top of which is connected hook (11) which includes a horizontal component. Membrane circuit (20) and rubber assembly (30) each have an opening (21) (31), respectively, to receive hook (11).

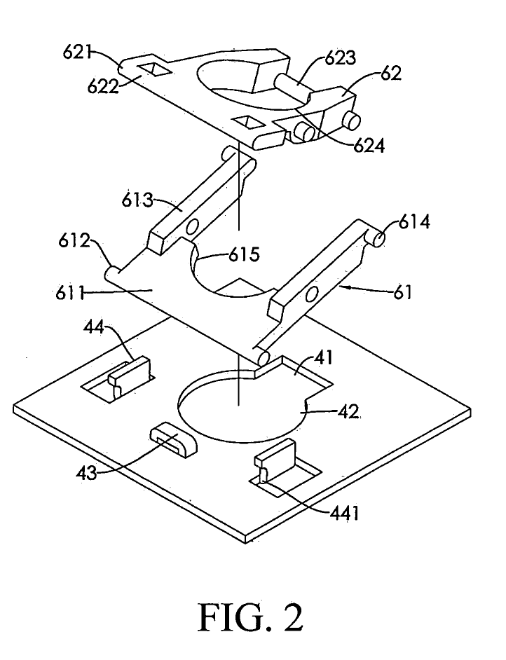

Referring to FIG. 2, bridging device support board (40) is a generally flat board which is positioned above rubber assembly (30). Hook opening (41) of bridging device support board (40) receives hook (11), while rubber cone opening (42) receives rubber cone (32). Stopper (43) and rod retainers (44) also comprise bridging device support board (40). There is also a retaining cut (441) on each rod retainer (44). Stopper (43) and retaining cuts (441) work together to prevent one end of first bridging frame (61) from sliding.

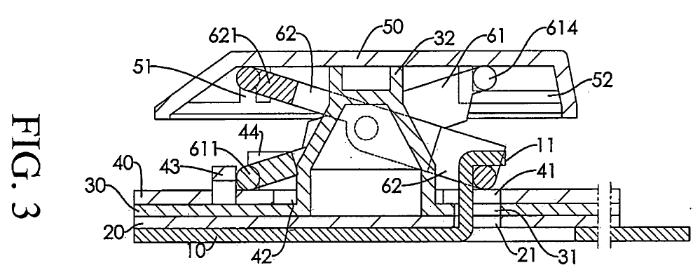

Referring to FIG. 1 and FIG. 3, keycap (50) is displaced above bridging device support board (40). On the edge of keycap (50) located above stopper (43), there are two rod retainers (51). On the edge of keycap (5) opposite rod retainers (51), there are two horizontal strips (52) that provide space for outward pins (614) of first bridging frame (61) to slide in.

Referring to FIG. 2, bridging device (60) is affixed between keycap (50) and bridging device support board (40). It includes first bridging frame (61) and second bridging frame (62), which are pivotally connected. First bridging frame (61) has a rod component (611) that is held between two retaining cuts (441) and stopper (43) which are both affixed to bottom support board (40). The other end of first bridging frame (61) has two outward pins (614) which are secured in place by horizontal strips (52) on the bottom of keycap (50). First bridging frame (61) has space (615) near its center to receive rubber cone (32).

Second bridging frame (62) comprises rod components (622) on one end which are held in the retainer holes of rod retainers (51) of keycap (50). The other end of second bridging frame (62) comprises rod component (623) which, when assembled and used in a keyswitch assembly, rests between the horizontal component of the hook (11) and bridging device support board (40). Rod component (623) is allowed to slide horizontally except when restricted by the vertical component of hook (11). Second bridging frame (62) comprises space (624) near its center to receive rubber cone (32).

Keycap (50) is supported by bridging device (60), which is joined at a pivot, so that keycap (50) remains generally horizontal during movement and use. The pivotally connected bridging device (60) allows keycap (50) to perform its generally vertical movement during use. Even though rubber cone (32) provides an upward force on keycap (50), hook (11) limits the maximum key stroke by using its vertical component to control how far rod component (623) can slide.

To adjust the maximum key stroke of a keyboard design employing the present invention, the only adjustments necessary would be the distance between hook (11) and bridging device (60). By moving the base of hook (11) towards stopper (43), the maximum key stroke could be increased. The reverse is also true, as moving the base of hook (11) away from stopper (43) would reduce the maximum key stroke. This means that even when designing keyboards of varying key strokes, all of the same components can be used so long as the distance between hook (11) and stopper (43) is adjusted accordingly. This greatly reduces the cost of designing and manufacturing a new keyboard as compared to existing technologies.

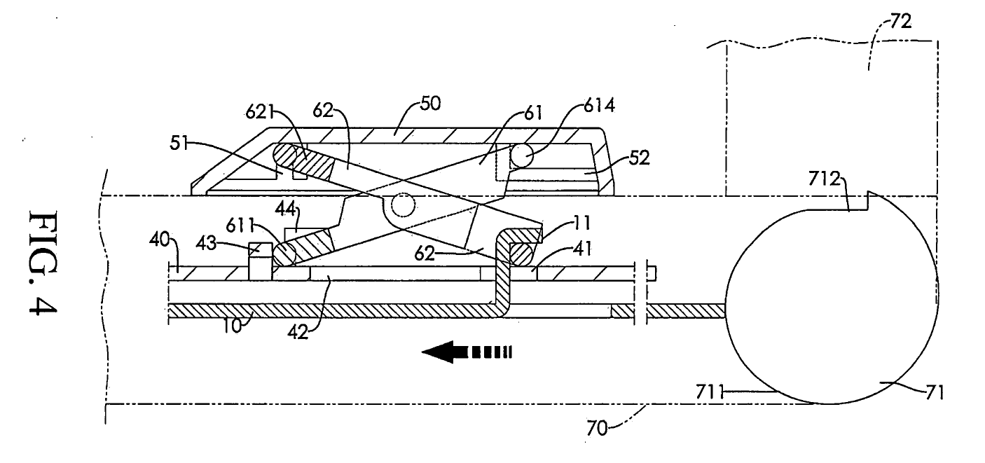

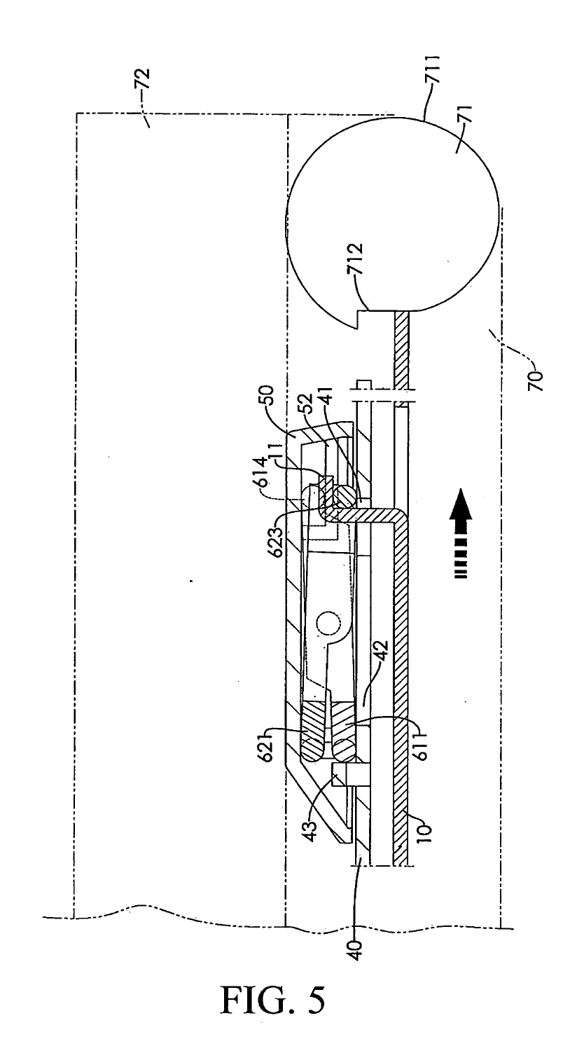

Referring to FIG. 4 and FIG. 5, the present invention may be applied to devices using open/close display panels—for example, a laptop or a notebook computer. Generally speaking, laptop and notebook computers comprise display panel (72), and can open and close by turning around pivotal axis (71). By allowing bottom plate (10) to interact with axis (71) in various ways, bottom plate (10) can move horizontally. When the notebook computer is opened, the rotation of axis (71) causes bottom plate (10) to move away from the axis, thereby allowing for greater maximum key stroke. When the notebook computer is closed, the rotation of the axis (71) causes bottom plate (10) to move towards the axis, eliminating the space normally used by the key stroke. As can be seen, this is a significant improvement over existing technologies.

What is claimed is:

1. A keyboard structure comprising:
a bottom plate;
a bridging device support board positioned above said bottom plate;
a plurality of keys positioned above said bridging device support board;
a plurality of bridging devices positioned between said bridging device support board and each of said plurality of keys, and
wherein said bottom plate is adapted to movably engage the said plurality of bridging devices for moving the said plurality of keys transversely relative to the said bottom plate.

2. The keyboard structure of claim 1, wherein the bridging device comprises a first bridging frame member held from sliding by one of said retainers on said support board at one end and slidably connected to its respective said key at the other end, and a second bridging frame member held from sliding at one end by it respective said key, and slidably connected to the support board and a respective hook at another end.

3. The keyboard structure of claim 1, wherein the bottom plate is adapted to slide relative to the support plate and the bridging devices.

4. The keyboard structure of claim 1, wherein the support board comprises a plurality of retainers coupling the support board to the plurality of bridging devices.

5. An electronic device comprising:
a keyboard structure, comprising:
a bottom plate;
a bridging device support board positioned above said bottom plate;
a plurality of keys positioned above said bridging device support board;
a plurality of bridging devices positioned between said bridging device support board and each of said plurality of keys;
a cover adapted to cover the keyboard structure;
a rotating member coupled to the cover and to the keyboard structure; and
wherein motion of the cover rotates the rotating member so that the bottom plate movably engages the plurality of bridging devices for moving the plurality keys transversely relative to the bottom plate.

6. The electronic device of claim 5, wherein the device is a computer notebook.

7. The electronic device of claim 5, wherein the rotating member comprises a cam-shape.
